(19) United States
(12) Patent Application Publication
(10) Pub. No.: US 2020/0152996 A1
(43) Pub. Date: May 14, 2020

(54) METHOD FOR PRODUCING ELECTRODE FOR HIGH TEMPERATURE POLYMER ELECTROLYTE MEMBRANE FUEL CELL AND MEMBRANE ELECTRODE ASSEMBLY USING ELECTRODE PRODUCED BY THE METHOD

(71) Applicant: KOREA INSTITUTE OF SCIENCE AND TECHNOLOGY, Seoul (KR)

(72) Inventors: Hyoung-Juhn KIM, Seoul (KR); Min Jae LEE, Seoul (KR); Ju Sung LEE, Seoul (KR); Katie Heeyum LIM, Seoul (KR); So Young LEE, Seoul (KR); Hee-Young PARK, Seoul (KR); Hyun Seo PARK, Seoul (KR); Jin Young KIM, Seoul (KR); Sung Jong YOO, Seoul (KR); Jong Hyun JANG, Seoul (KR)

(73) Assignee: KOREA INSTITUTE OF SCIENCE AND TECHNOLOGY, Seoul (KR)

(21) Appl. No.: 16/386,395

(22) Filed: Apr. 17, 2019

(30) Foreign Application Priority Data
Nov. 8, 2018 (KR) 10-2018-0136405

(51) Int. Cl. H01M 4/88; H01M 8/1004; H01M 4/86; H01M 4/92; H01M 8/103

(52) U.S. Cl. CPC H01M 4/8825; H01M 8/1004; H01M 4/8668; H01M 2008/1095; H01M 4/92; H01M 8/103; H01M 4/8807

(57) ABSTRACT

Disclosed is a method for producing an electrode for a high temperature polymer electrolyte membrane fuel cell. According to the method, a catalyst slurry containing a uniformly dispersed binder is used to produce an electrode. Also disclosed are a membrane electrode assembly using the electrode and a high temperature polymer electrolyte membrane fuel cell including the membrane electrode assembly. Uniform distribution of the binder leads to improvements in the performance and reproducibility of the fuel cell.

### CROSS-REFERENCE TO RELATED APPLICATIONS

This application claims priority under 35 U.S.C. § 119 to Korean Patent Application No. 10-2018-0136405 filed on Nov. 8, 2018 in the Korean Intellectual Property Office, the disclosure of which is incorporated herein by reference in its entirety.

### BACKGROUND OF THE INVENTION

### 1. Field of the Invention

The present invention relates to a method for producing an electrode for a high temperature polymer electrolyte membrane fuel cell and a membrane electrode assembly using an electrode produced by the method. More specifically, the present invention relates to a technology in which a catalyst slurry containing a uniformly dispersed binder is used to manufacture a fuel cell whose performance is maintained without deterioration.

### 2. Description of the Related Art

There has recently been continuous research on proton exchange membrane fuel cells as alternative clean energy sources for fossil fuel-based energy production and storage. Particularly, high temperature polymer electrolyte membrane fuel cells operating at temperatures of 100° C. to 200° C. provide many advantages, including improved electrode reaction kinetics, superior water and heat management, high resistance to fuel impurities, and optimal waste heat utilization, compared to low temperature polymer electrolyte membrane fuel cell systems operating at 100° C. or less (S. Han, et al., Journal of Sensors, 2016 (2015)).

Fuel cells are power generation systems that directly convert chemical energy of hydrogen and oxygen contained in hydrocarbon-based materials (e.g., methanol, ethanol, and natural gas) into electric energy through electrochemical reactions.

Particularly, polymer electrolyte membrane fuel cells (PEMFCs) have the advantages of low operating temperature, high energy density, good corrosion resistance, and ease of handling. Due to these advantages, polymer electrolyte membrane fuel cells (PEMFCs) are considered clean efficient energy converting devices that can be used as mobile or stationary power sources.

Fuel cell systems consist of a series of components, for example, a membrane electrode assembly (MEA) and a bipolar plate for current collection and fuel supply.

Generally, a binder is used to produce an electrode for a high temperature polymer electrolyte membrane fuel cell. The binder plays an important role in properly distributing phosphoric acid as an electrolyte and forming fuel gas passages in a catalyst layer of the electrode, affecting the performance of the fuel cell. That is, uniform distribution of the binder in the catalyst layer leads to improvements in the performance and reproducibility of the fuel cell and the maintenance of the binder dispersed in a catalyst slurry is thus considered a very important factor. The binder tends to aggregate during calcination, resulting in rapid precipitation (Korean Patent Publication No. 2018-0002089).

Thus, there is a need to provide a method for producing an electrode for a high temperature polymer electrolyte membrane fuel cell in which a binder does not settle and is kept uniformly dispersed in a catalyst slurry, achieving improved performance and reproducibility of the fuel cell, a membrane electrode assembly using an electrode produced by the method, and a fuel cell using the membrane electrode assembly.

### SUMMARY OF THE INVENTION

The present invention has been made in view of the problems of the prior art, and it is one object of the present invention to provide a method for producing an electrode for a high temperature polymer electrolyte membrane fuel cell in which a binder material is uniformly dispersed in a catalyst slurry, achieving improved performance and reproducibility of the fuel cell.

It is a further object of the present invention to provide a membrane electrode assembly using an electrode produced by the method.

It is another object of the present invention to provide a high temperature polymer electrolyte membrane fuel cell including the membrane electrode assembly.

One representative aspect of the present invention is directed to a method for producing an electrode for a high temperature polymer electrolyte membrane fuel cell, including (A) adding a binder to a surfactant solution, (B) adding a catalyst to the mixture to prepare a catalyst slurry, and (C) applying the catalyst slurry onto an electrode support.

In step (A), a binder is added to a surfactant solution. The mixture is preferably dispersed by sonication for 1 to 30 minutes.

The surfactant solution includes a surfactant, distilled water, and isopropyl alcohol.

The surfactant is preferably selected from fluorosurfactants, silicone surfactants, nonionic surfactants, cationic surfactants, anionic surfactants, and mixtures thereof.

Preferably, the binder includes at least one polymer selected from fluorinated polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyetheretherketone-based polymers, and polyphenylquinoxaline-based polymers.

The catalyst is preferably a metal catalyst or a carbon-supported metal catalyst.

The metal catalyst includes at least one metal or alloy selected from platinum, ruthenium, osmium, platinum-ruthenium alloys, platinum-osmium alloys, platinum-palladium alloys, and platinum-M alloys (M is gallium, titanium, vanadium, chromium, manganese, iron, cobalt, nickel, copper or zinc).

The application is preferably performed by at least one technique selected from bar coating, spray coating, and brushing.

A further representative aspect of the present invention is directed to a method for fabricating a membrane electrode assembly for a high temperature polymer electrolyte membrane fuel cell, including (D) annealing a polymer electrolyte membrane and (E) disposing the polymer electrolyte membrane at at least one side of an electrode produced by the production method and assembling the polymer electrolyte membrane with the electrode.

Preferably, the electrolyte membrane includes at least one polymer selected from perfluorosulfonic acid polymers, perfluorocarbon sulfonic acid polymers, hydrocarbon-based polymers, polyimide, polyvinylidene fluoride, polyethersulfone, polyphenylene sulfide, polyphenylene oxide, polyphosphazene, polyethylene naphthalate, polyester, polyetherketone, polysulfone, meta-polybenzimidazole, para-polybenzimidazole, poly[2-5-benzimidazole], and inorganic acid-doped polybenzimidazole.

The annealing is preferably performed at a temperature of 100 to 130° C. for 1 to 2 hours. Another representative aspect of the present invention is directed to a high temperature polymer electrolyte membrane fuel cell including a membrane electrode assembly fabricated by the fabrication method.

According to the production method of the present invention, a binder material is uniformly dispersed in a catalyst slurry in the manufacture of a high temperature polymer electrolyte membrane fuel cell, achieving improved performance and reproducibility of the fuel cell. The production method of the present invention can be used to provide a membrane electrode assembly and a high temperature polymer electrolyte membrane fuel cell including the membrane electrode assembly.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B show photographs comparing the states of polytetrafluoroethylene dispersed in a solvent with a fluorosurfactant (FC-4430) in Example 1 and in a solvent without the fluorosurfactant in Comparative Example 1. Specifically, the photographs of FIGS. 1A and 1B were taken immediately and 1 hour after dispersion, respectively;

FIG. 2 is a photograph showing an electrode produced in Example 1;

FIG. 3 shows current-voltage curves for high temperature polymer electrolyte membrane fuel cells using membrane electrode assemblies fabricated in Comparative Example 2, which were measured to analyze the electrochemical properties of the fuel cells; and

FIG. 4 shows current-voltage curves for high temperature polymer electrolyte membrane fuel cells using membrane electrode assemblies fabricated in Example 2, which were measured to analyze the electrochemical properties of the fuel cells.

### DETAILED DESCRIPTION OF THE INVENTION

Several aspects and various embodiments of the present invention will now be described in more detail.

One aspect of the present invention provides a method for producing an electrode for a high temperature polymer electrolyte membrane fuel cell, including (A) adding a binder to a surfactant solution, (B) adding a catalyst to the mixture to prepare a catalyst slurry, and (C) applying the catalyst slurry onto an electrode support.

In step (A), a binder is added to a surfactant solution.

Preferably, the surfactant solution includes a surfactant, distilled water, and isopropyl alcohol.

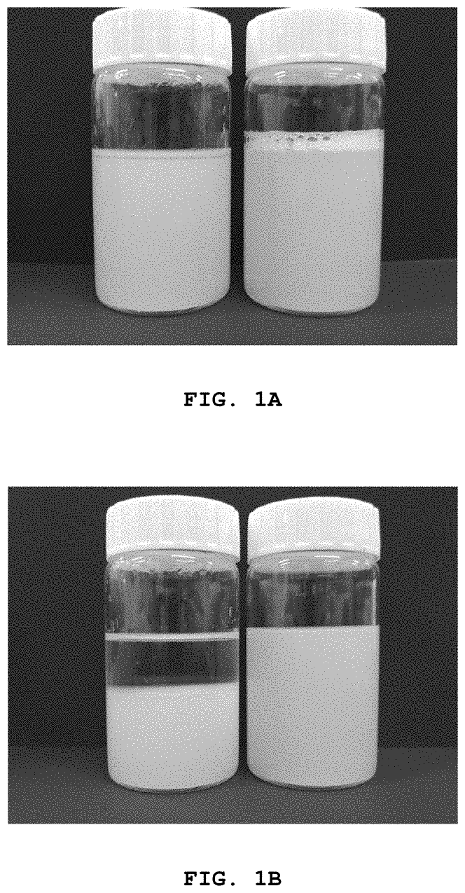

The surfactant serves to uniformly disperse the binder in a catalyst slurry in the subsequent step. For uniform dispersion of the binder in the catalyst slurry, the surfactant needs to be mixed in a solution state with the binder. This can be identified directly with naked eyes (see FIGS. 1A and 1B). Specifically, FIG. 1A is a photograph taken immediately after dispersion of the binder. There is no substantial difference regardless of whether the surfactant is present or not. FIG. 1B is a photograph taken 1 hour after dispersion of the binder. The surfactant is absent in the left solution. The binder is settled down at the bottom of the solution and layer separation is observed. In contrast, the binder is uniformly dispersed in the right solution containing the surfactant. From these observations, it can be concluded that the surfactant plays a critical role in the dispersion of the binder.

Specifically, the surfactant is selected from fluorosurfactants, silicone surfactants, nonionic surfactants, cationic surfactants, anionic surfactants, and mixtures thereof. The surfactant is preferably a fluorosurfactant.

The fluorosurfactant may be selected from Novec® surfactants available from 3M, Zonyl® surfactants available from DuPont, and mixtures thereof. Specifically, the Novec® surfactants may be Novec® 4200 (ammonium fluoroalkylsulfonamide), Novec® 4300 (ammonium fluoroalkylsulfonate), Novec® 4430 (polymeric fluorochemical active), and Novec® 4432 (polymeric fluorochemical actives). For example, the Zonyl® surfactants may be Zonyl® TBS (RfCH₂CH₂SO₃X (X═H or NH₄), Rf═F(CF₂CF₂)₃₋₈), Zonyl® FSN (RfCH₂CH₂O(CH₂CH₂O)ₓH)), and Zonyl® FSP (RfCH₂CH₂O)P(O)(ONH₄)₂. The fluorosurfactant is more preferably Novec® 4430 (polymeric fluorochemical active). The use of Novec® 4430 causes no deterioration in the electrochemical properties of a fuel cell.

The binder may include at least one polymer selected from fluorinated polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyetheretherketone-based polymers, and polyphenylquinoxaline-based polymers.

More specifically, the binder is preferably polytetrafluoroethylene, polyvinylidene fluoride, vinylidene fluoride-hexafluoropropylene copolymers, styrene butadiene rubbers, polyurethane, and mixtures thereof. More preferably, the binder is polytetrafluoroethylene that can suppress the emission of an inorganic acid from a polymer electrolyte membrane.

In step (B), a catalyst is added to the mixture to prepare a catalyst slurry.

The catalyst may be a metal catalyst or a carbon-supported metal catalyst that can catalytically support reactions (oxidation of hydrogen and reduction of oxygen) in a fuel cell.

Preferably, the metal catalyst includes at least one metal or alloy selected from platinum, ruthenium, osmium, platinum-ruthenium alloys, platinum-osmium alloys, platinum-palladium alloys, and platinum-M alloys (M is at least one transition metal selected from gallium, titanium, vanadium, chromium, manganese, iron, cobalt, nickel, copper, and zinc).

The carbon support may include at least one carbon material selected from graphite, carbon black, acetylene black, denka black, ketjen black, activated carbon, mesoporous carbon, carbon nanotubes, carbon nanofibers, carbon nanohorns, carbon nanorings, carbon nanowires, fullerenes (C60), and Super P.

More preferably, the catalyst is platinized carbon (Pt/C) that contains 40 to 50% by weight of platinum, based on the total weight thereof.

In step (C), the catalyst slurry is applied onto an electrode support.

The electrode support may be a gas diffusion layer and may be composed of a conductive material. The gas diffusion layer serves to support an electrode for a fuel cell. A reaction gas is diffused through the gas diffusion layer to reach the catalyst layer.

The application is preferably performed by bar coating, spray coating or brushing.

More preferably, the method further includes annealing the electrode under an argon atmosphere at a temperature of 200 to 500° C. for 1 to 5 hours. Outside this temperature range, the electrode may be cracked.

The electrode produced by the method may be used in either an anode or a cathode or both.

A further aspect of the present invention provides a method for fabricating a membrane electrode assembly for a high temperature polymer electrolyte membrane fuel cell, including (D) annealing a polymer electrolyte membrane and (E) disposing the polymer electrolyte membrane at at least one side of an electrode produced by the production method and assembling the polymer electrolyte membrane with the electrode.

In step (D), a polymer electrolyte membrane is annealed.

The annealing is preferably performed at a temperature of 100 to 130° C. for 1 to 2 hours. If the temperature and time exceed the respective ranges, the electrolyte membrane may be cracked.

The polymer electrolyte membrane may be composed of an ionomer. Specifically, the polymer electrolyte membrane may include at least one polymer selected from perfluorosulfonic acid polymers, perfluorocarbon sulfonic acid polymers, hydrocarbon-based polymers, polyimide, polyvinylidene fluoride, polyethersulfone, polyphenylene sulfide, polyphenylene oxide, polyphosphazene, polyethylene naphthalate, polyester, polyetherketone, polysulfone, meta-polybenzimidazole, para-polybenzimidazole, poly[2-5-benzimidazole], and inorganic acid-doped polybenzimidazole. Preferably, the polymer electrolyte membrane is a phosphoric acid-doped polybenzimidazole polymer electrolyte membrane.

For example, the polymer electrolyte membrane may include polybenzimidazole doped with an inorganic acid such as phosphoric acid. In this case, the method may further include doping phosphoric acid into polybenzimidazole before the annealing.

In step (E), the polymer electrolyte membrane is disposed at at least one side of an electrode produced by the production method and is assembled with the electrode. As described previously, the electrode may be used in either an anode or a cathode or both.

Another aspect of the present invention provides a fuel cell including a membrane electrode assembly fabricated by the fabrication method.

The present invention will be explained in more detail with reference to the following examples. However, these examples are not to be construed as limiting or restricting the scope and disclosure of the invention. It is to be understood that based on the teachings of the present invention including the following examples, those skilled in the art can readily practice other embodiments of the present invention whose experimental results are not explicitly presented. Such modifications and variations are intended to come within the scope of the appended claims.

The experimental results of the following examples, including comparative examples, are merely representative and the effects of the exemplary embodiments of the present invention that are not explicitly presented hereinafter can be specifically found in the corresponding sections.

### Preparative Example 1: Preparation of Phosphoric Acid-Doped p-Polybenzimidazole (p-PBI) Membrane

Dried 3.3′-diaminobenzidine (3 g), terephthalic acid (2.3497 g), and polyphosphoric acid (125 g) were stirred in a round-bottom flask under an argon atmosphere at a temperature of 150° C. for 15 h. Thereafter, the mixture was heated to 220° C. and stirred for 4-7 h. After a desired viscosity was reached, phosphoric acid (50 ml) was added to stop the reaction. The reaction mixture was stirred for 2-3 h to completely dissolve the polymer in the phosphoric acid. The polymer mixture was poured onto a glass plate and cast with a doctor blade. The cast polymer was hydrolyzed in a humidifying chamber at a temperature of 50° C. and an RH of 80% for 24 h to prepare a polymer electrolyte membrane.

### Example 1: Preparation of Catalyst Slurry Using Surfactant and Production of Anode Electrode Using the Catalyst Slurry

Distilled water (10.6 g) and isopropyl alcohol (10.6 g) were added to Novec® FC-4430 (3M, 1 g). The surfactant was dispersed by ultrasonication to prepare a surfactant solution. Polytetrafluoroethylene (PTFE, 2.054 g) was dispersed in the surfactant solution by tip sonication for 10 min. The resulting solution was added to 46.2% Pt/C (3.858 g), subjected to tip sonication for 25 min, and dispersed using a homogenizer for 1 h to prepare a catalyst slurry. The catalyst slurry was bar-coated on a gas diffusion layer (GDL) using a film applicator to produce an electrode containing 0.6 mg/cm² of Pt. The electrode was annealed under an argon atmosphere at a temperature of 350° C. for 2 h to produce a final anode electrode.

### Example 2: Fabrication of Membrane Electrode Assembly

The phosphoric acid-doped polybenzimidazole (PBI) electrolyte membrane prepared in Preparative Example 1 was annealed in an oven at a temperature of 130° C. for 30 min. The polybenzimidazole is represented by the following formula.

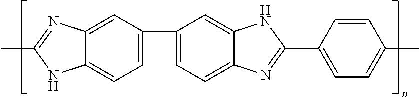

A phosphoric acid solution was mixed with an ethanol solution in a ratio of 1:6. The mixture solution was applied to the surface of a cathode electrode (Pt content=1.0 mg/cm², BASF) using a brush and annealed in an oven at a temperature of 130° C. for 1 h. The anode electrode produced in Example 1, the annealed electrolyte membrane, and the cathode electrode were assembled with Teflon and a Kapton gasket to fabricate a membrane electrode assembly.

### Comparative Example 1: Preparation of Catalyst Slurry without Surfactant and Production of Anode Electrode Using the Catalyst Slurry

A catalyst slurry was prepared in the same manner as in Example 1, except that FC-4430 was not used. An anode electrode was produced using the catalyst slurry in the same manner as in Example 1.

### Comparative Example 2: Fabrication of Membrane Electrode Assembly

A membrane electrode assembly was fabricated in the same manner as in Example 2, except that the anode electrode produced in Comparative Example 1 was used instead of the anode electrode produced in Example 1.

FIGS. 1A and 1B show photographs comparing the states of PTFE dispersed in the solvent with FC-4430 in Example 1 and in the solvent without FC-4430 in Comparative Example 1.

Specifically, FIG. 1A is a photograph taken immediately after dispersion. There is no substantial difference regardless of whether FC-4430 is present or not. FIG. 1B is a photograph taken 1 hour after dispersion. FC-4430 is absent in the left solution. PTFE is settled down at the bottom of the solution and layer separation is observed. In contrast, PTFE is uniformly dispersed in the right solution containing FC-4430.

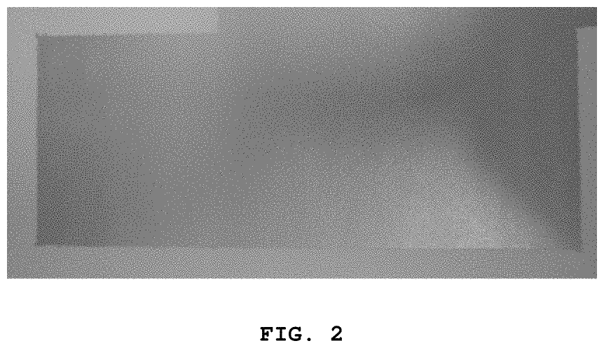

FIG. 2 is a photograph showing the electrode produced in Example 1. The appearance of the electrode can be visually observed from FIG. 2.

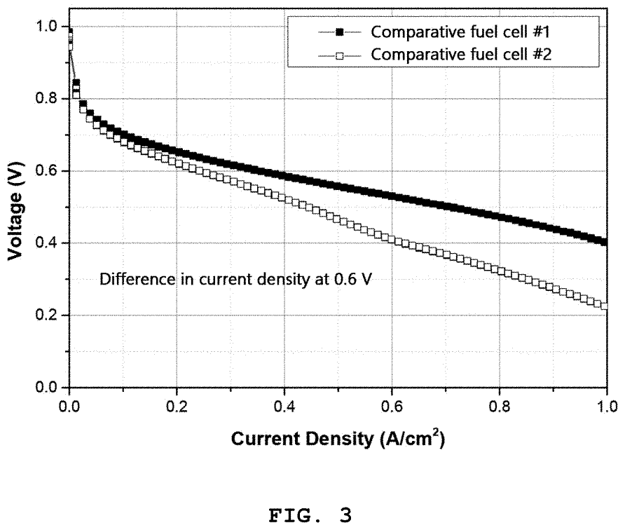

FIG. 3 shows the electrochemical properties of high temperature polymer electrolyte membrane fuel cells using two membrane electrode assemblies fabricated in Comparative Example 2, which were analyzed to investigate the reproducibility of the fuel cells.

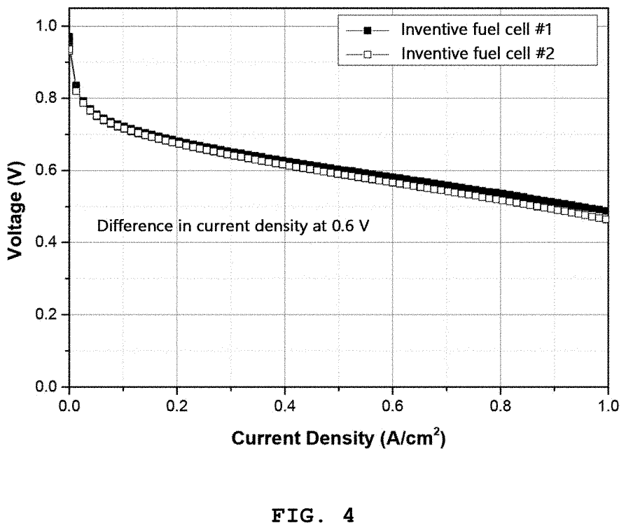

FIG. 4 shows the electrochemical properties of high temperature polymer electrolyte membrane fuel cells using two membrane electrode assemblies fabricated in Example 2, which were analyzed to investigate the reproducibility of the fuel cells.

In each of the current-voltage curves of FIGS. 3 and 4, the x-axis represents the current density in A/cm² and the y-axis represents the voltage (V).

As is apparent from the foregoing, according to the present invention, the electrode is produced using the catalyst slurry containing the uniformly dispersed binder material. The performance of the high temperature polymer electrolyte membrane fuel cell including the membrane electrode assembly using the electrode is maintained without deterioration.

What is claimed is:

1. A method for producing an electrode for a high temperature polymer electrolyte membrane fuel cell, comprising (A) adding a binder to a surfactant solution, (B) adding a catalyst to the mixture to prepare a catalyst slurry, and (C) applying the catalyst slurry onto an electrode support.

2. The method according to claim 1, wherein the surfactant solution comprises a surfactant, distilled water, and isopropyl alcohol; and the surfactant is selected from fluorosurfactants, silicone surfactants, nonionic surfactants, cationic surfactants, anionic surfactants, and mixtures thereof.

3. The method according to claim 1, wherein, in step (A), the mixture is dispersed by sonication for 1 to 30 minutes.

4. The method according to claim 1, wherein the binder comprises at least one polymer selected from fluorinated polymers, benzimidazole-based polymers, polyimide-based polymers, polyetherimide-based polymers, polyphenylene sulfide-based polymers, polysulfone-based polymers, polyethersulfone-based polymers, polyetherketone-based polymers, polyetheretherketone-based polymers, and polyphenylquinoxaline-based polymers.

5. The method according to claim 1, wherein the catalyst is a metal catalyst or a carbon-supported metal catalyst; and the metal catalyst comprises at least one metal or alloy selected from platinum, ruthenium, osmium, platinum-ruthenium alloys, platinum-osmium alloys, platinum-palladium alloys, and platinum-M alloys (M is gallium, titanium, vanadium, chromium, manganese, iron, cobalt, nickel, copper or zinc).

6. The method according to claim 1, wherein the application is performed by at least one technique selected from bar coating, spray coating, and brushing.

7. A method for fabricating a membrane electrode assembly for a high temperature polymer electrolyte membrane fuel cell, comprising (D) annealing a polymer electrolyte membrane and (E) disposing the polymer electrolyte membrane at at least one side of an electrode produced by the method according to claim 1 and assembling the polymer electrolyte membrane with the electrode.

8. The method according to claim 7, wherein the electrolyte membrane is a perfluorosulfonic acid polymer, perfluorocarbon sulfonic acid polymer, hydrocarbon-based polymer, polyimide, polyvinylidene fluoride, polyethersulfone, polyphenylene sulfide, polyphenylene oxide, polyphosphazene, polyethylene naphthalate, polyester, polyetherketone, polysulfone, meta-polybenzimidazole, para-polybenzimidazole, poly[2-5-benzimidazole] or inorganic acid-doped polybenzimidazole.

9. The method according to claim 7, wherein the annealing is performed at a temperature of 100 to 130° C. for 1 to 2 hours.
